(19) United States
(12) Patent Application Publication
(10) Pub. No.: US 2020/0025117 A1
(43) Pub. Date: Jan. 23, 2020

(54) CONTROLLER FOR INTERNAL COMBUSTION ENGINE

(71) Applicant: TOYOTA JIDOSHA KABUSHIKI KAISHA, Toyota-shi (JP)

(72) Inventor: Hayato SHIRAI, Sunto-gun (JP)

(73) Assignee: TOYOTA JIDOSHA KABUSHIKI KAISHA, Toyota-shi (JP)

(21) Appl. No.: 16/507,668

(22) Filed: Jul. 10, 2019

(30) Foreign Application Priority Data
Jul. 19, 2018 (JP) 2018-135991

(51) Int. Cl. F02D 41/00; F02D 11/10; F02D 41/14

(52) U.S. Cl. CPC F02D 41/0052; F02D 41/0205; F02D 41/1441; F02D 11/105

(57) ABSTRACT

A controller having a part for calculating provisional target values of a plurality of control outputs, a reference governor for deriving target values of the control outputs by correcting the provisional target values, and a feedback controller for determining control inputs so that the values of the control outputs approach the target values. The reference governor derives the target values by correcting the provisional target values of the plurality of control outputs using a calculation model which outputs a relationship between the correction amounts from the provisional target values of the plurality of control outputs, by inputting the current values of the state quantities a ratio of the correction amounts from the provisional target values between the plurality of control outputs is set to a predetermined correction ratio. The correction ratio is set based on the values of the operating parameters of the internal combustion engine.

### FIELD

The present invention relates to a controller for an internal combustion engine.

### BACKGROUND

Known in the past have been controllers for internal combustion engines which correct target values of control outputs of the internal combustion engine using a reference governor so that the degree of satisfaction of constraint conditions related to state quantities of the internal combustion engine is high (for example, PTL 1 to 3).

In such reference governors, the final target values of the control outputs are calculated by performing iterative calculation so that the degree of satisfaction of constraint conditions is high. However, when iterative calculation is performed in this manner, the calculation load on the controller of the internal combustion engine is high.

A reference governor which derives final target values by means of a prediction model that outputs target values of control outputs when the current state quantities and constraint conditions of the internal combustion engine are input, in the case in which it is expected that the constraint conditions related to the state quantities will not be satisfied in the future assuming that the target values of the control outputs have been set to initial provisional target values, has been proposed (PTL 1).

### CITATION LIST

### Patent Literature

### [PTL 1] Japanese Unexamined Patent Publication (Kokai) No. 2016-130480

### [PTL 2] Japanese Unexamined Patent Publication (Kokai) No. 2016-169688

### [PTL 3] Japanese Unexamined Patent Publication (Kokai) No. 2017-20357

### SUMMARY

### Technical Problem

In the prediction model of PTL 1, there is only one control output (DPF bed temperature) for which a target value is output, whereby the prediction model has only a single variable. However, when deriving the target values of a plurality of control outputs using such a prediction model, there are multiple variables in the prediction model. Thus, if there are multiple variables in the prediction model, it is not possible to derive the value of each variable univocally by the prediction model, and as a result, the target values of the plurality of control outputs cannot be simply calculated from the prediction model.

The present invention has been achieved in view of the problems described above and aims to provide a controller for an internal combustion engine comprising a reference governor which can derive target values of a plurality of control outputs with a low computational load.

### Solution to Problem

The present invention was made so as to solve the above problem and has as its gist the following.

(1) A controller for an internal combustion engine, comprising: a provisional target value calculation part for calculating provisional target values of a plurality of control outputs of the internal combustion engine based on values of operating parameters of the internal combustion engine, a reference governor for deriving target values of the control outputs by correcting the provisional target values so that a degree of satisfaction of constraint conditions related to state quantities of the internal combustion engine is high when it is predicted that the constraint conditions related to the state quantities of the internal combustion engine will not be satisfied in the future assuming that the target values of the plurality of control outputs are set to the respective provisional target values, and a feedback controller for determining control inputs of the internal combustion engine so that the values of the control outputs approach the target values, wherein the reference governor derives the target values by correcting the provisional target values of the plurality of control outputs, based on the current values of the state quantities, so as to satisfy the constraint conditions related to the state quantities, using a calculation model which outputs a relationship between the correction amounts from the provisional target values of the plurality of control outputs, such that the constraint conditions of the state quantities are satisfied, by inputting the current values of the state quantities, and when deriving the target values, a ratio of the correction amounts from the provisional target values between the plurality of control outputs is set to a predetermined correction ratio, and the correction ratio is set based on the values of the operating parameters of the internal combustion engine.

(2) The controller for an internal combustion engine according to claim 1, wherein the correction ratio is set so that the correction amount from the provisional target value of a control output having a high sensitivity to the state quantities among the plurality of control outputs is relatively high compared to the correction amounts of the provisional target values of the other control outputs.

(3) The controller for an internal combustion engine according to claim 1 or 2, wherein when a calculation load of the controller is lower than a predetermined load, the reference governor derives the target value without the use of the calculation model so that the value of an objective function, which becomes smaller as the degree of satisfaction of the constraint conditions related to the state quantity becomes higher, decreases.

(4) The controller for an internal combustion engine according to any one of claims 1 to 3, wherein the internal combustion engine comprises an exhaust turbocharger, and the state quantities include a turbine rotation speed of the exhaust turbocharger, and the constraint conditions include a condition in which the turbine rotation speed is equal to or lower than a predetermined rotational speed.

(5) The controller for an internal combustion engine according to any one of claims 1 to 4, wherein the state quantities include an exhaust pressure, and the constraint conditions include a condition in which the exhaust pressure is equal to or lower than a predetermined pressure.

(6) The controller for an internal combustion engine according to any one of claims 1 to 5, wherein the internal combustion engine comprises an exhaust turbocharger and an EGR system, and the control outputs include boost pressure and EGR rate.

(7) The controller for an internal combustion engine according to any one of claims 1 to 6, wherein when it is predicted that the constraint conditions related to the plurality of state quantities of the internal combustion engine will be not satisfied assuming that the target values of the plurality of control outputs have been set to the respective provisional target values, the reference governor derives the target values by correcting the provisional target values of the plurality of control outputs so as to satisfy the constraint condition related to a state quantity having a greater degree of conflict with the constraint conditions from among the plurality of state quantities.

(8) The controller for an internal combustion engine according to any one of claims 1 to 7, wherein the reference governor comprises a prediction model for outputting future values of the state quantities when the target values of the control outputs and the current values of the state quantities are input, and an inverse prediction model for outputting the target values of the control outputs when the current values and future values of the state quantities are input, the reference governor judges whether or not the constraint conditions will be satisfied in the future based on future values of the state quantities obtained by inputting the provisional target values of the control outputs and the current values of the state quantities to the prediction model, and the calculation model is an inverse prediction model.

### Advantageous Effects of Invention

According to the present invention, there is provided a controller for an internal combustion engine comprising a reference governor which can derive target values of a plurality of control outputs with a low computational load.

### BRIEF DESCRIPTION OF DRAWINGS

FIG. 1 is a schematic view of a configuration of an internal combustion engine using a controller according to an embodiment.

FIG. 2 is a block diagram schematically showing control performed by the controller.

FIG. 3 is a map for calculating provisional target values based on engine rotation speed and fuel injection quantity.

FIG. 4 is a flowchart showing a control routine of target value derivation processing in an embodiment.

FIG. 5 is a view schematically showing a turbine rotation speed future prediction model.

FIG. 6 is a view schematically showing an inverse model of the turbine speed future prediction model.

FIG. 7 is a flowchart showing a control routine of target value calculation processing for calculating the target values of boost pressure and EGR rate, which are control outputs.

FIG. 8 is a view schematically showing an exhaust pressure future prediction model.

FIG. 9 is a view schematically showing an inverse model of the exhaust pressure future prediction model.

FIG. 10 is a flowchart showing a control routine of target value calculation processing for calculating target values of boost pressure and EGR rate, which are control outputs.

### DESCRIPTION OF EMBODIMENT

Below, referring to the drawings, embodiments of the present invention will be explained in detail. Note that, in the following explanation, similar component elements are assigned the same reference numerals.

### First Embodiment

### <<Explanation of Internal Combustion Engine as a Whole>>

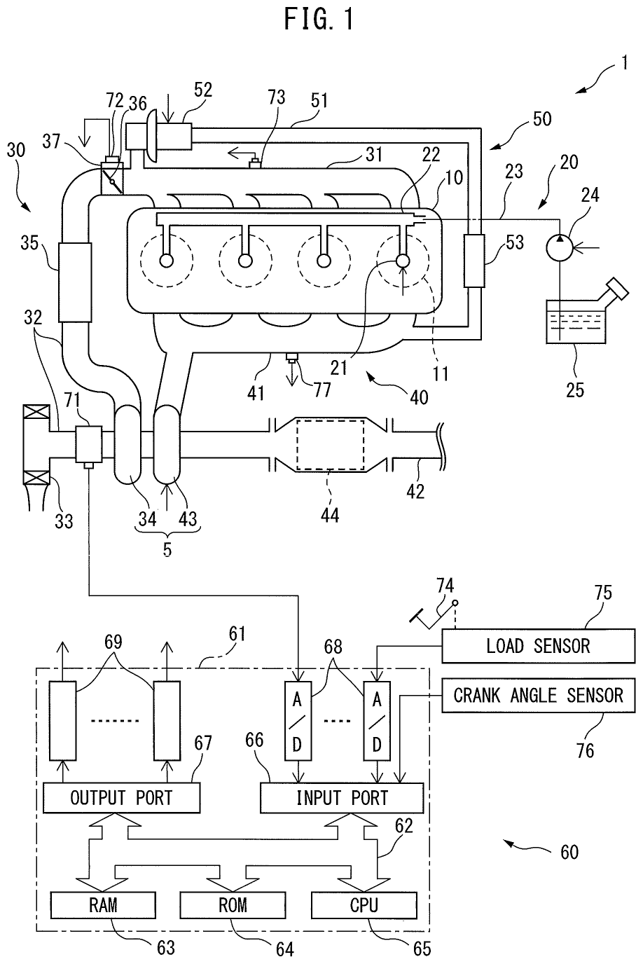

First, referring to FIG. 1, the configuration of an internal combustion engine 1 in which a control device according to the first embodiment is used, will be explained. FI″. 1 is schematic view of the configuration of the internal combustion engine 1. The internal combustion engine of the present embodiment is a compression self-ignition type internal combustion engine using diesel oil as fuel. As shown in FIG. 1, the internal combustion engine 1 comprises an engine body 10, fuel feed system 20, intake system 30, exhaust system 40, exhaust gas recirculation (EGR) mechanism 50, and control device 60.

The engine body 10 comprises a cylinder block in which a plurality of cylinders 11 are formed, a cylinder head in which intake ports and exhaust ports are formed, and crank case. In each cylinder 11, a piston 14 is arranged, and each cylinder 11 is communicated with the intake ports and the exhaust ports.

The fuel feed system 20 comprises fuel injectors 21, a common rail 22, fuel feed pipe 23, fuel pump 24, and fuel tank 25. Each fuel injector 21 is arranged in the cylinder head so as to directly inject fuel into a combustion chamber of a cylinder 11. The fuel injector 21 is communicated through the common rail 22 and fuel feed pipe 23 to the fuel tank 25. At the fuel feed pipe 23, the fuel pump 24 is arranged for pumping out fuel in the fuel tank 25. The fuel pumped out by the fuel pump 24 is supplied through the fuel feed pipe 23 to the common rail 22, and fuel is directly injected from the fuel injector 21 into the combustion chambers of the cylinders 11. Note that the fuel injector 21 may be configured to inject fuel into the intake port.

The intake system 30 comprises an intake manifold 31, intake pipe 32, air cleaner 33, compressor 34 of an exhaust turbocharger 5, intercooler 35, and throttle valve 36. The intake port of each cylinder 11 is communicated through the intake manifold 31 and the intake pipe 32 to the air cleaner 44. The intake pipe 32 is provided with the compressor 34 of the exhaust turbocharger 5 compressing and discharging intake air flowing through the intake pipe 43 and the intercooler 35 cooling the air compressed by the compressor 34. The throttle valve 36 can change the open area of the intake passage by being turned by a throttle valve drive actuator 37.

The exhaust system 40 comprises an exhaust manifold 41, exhaust pipe 42, turbine 43 of the exhaust turbocharger 5, and exhaust after-treatment device 44. The exhaust port of each cylinder 11 is communicated through the exhaust manifold 41 and the exhaust pipe 52 to the exhaust after-treatment device 44. At the exhaust pipe 42, the turbine 43 of the exhaust turbocharger 5 is provided. The turbine 43 is driven to rotate by the energy of the exhaust gas. If the turbine 43 of the exhaust turbocharger 5 is driven to rotate, along with this, the compressor 34 rotates and, accordingly, the intake air is compressed. In the present embodiment, variable nozzles are provided with the turbine 43 of the exhaust turbocharger 5. If the opening degree of the variable nozzles is changed, the flow rate of the exhaust gas supplied to the turbine blade is changed, and therefore the rotational speed of the turbine 43 is changed.

The exhaust after-treatment device 44 is a device for cleaning exhaust gas, then discharging the exhaust gas to the outside air. The exhaust after-treatment device 44 is provided with various types of exhaust purification catalysts and/or filters for trapping harmful substances for removing the harmful substances, etc. The after-treatment device 44 specifically includes at least one of a NOx selective reduction catalyst, NOx storage reduction catalyst, oxidation catalyst, and particulate filter, etc.

An EGR mechanism 50 comprises an EGR pipe 51, EGR control valve 52, and EGR cooler 53. The EGR pipe 51 is connected to the exhaust manifold 41 and intake manifold 31, and connect these together. At the EGR pipe 51, the EGR cooler 53 is provided for cooling EGR gas flowing through the EGR pipe 51. In addition, at the EGR pipe 51, the EGR control valve 62 able to change the open area of an EGR passage formed by the EGR pipe 61, is provided. By controlling the opening degree of the EGR control valve 52, the amount of flow of EGR gas recirculating from the exhaust manifold 41 to the intake manifold 31 is adjusted, and therefore an EGR rate is changed. Note that the EGR rate is a ratio of an amount of EGR gas with respect to the total amount of gas supplied to the combustion chamber (total amount of the fresh gas amount and EGR gas amount).

### <<Control Device of Internal Combustion Engine>>

The control device 60 comprises an electronic control unit (ECU) 61 and various types of sensors. The ECU 61 is comprised of a digital computer and comprises components, such as a RAM (random access memory) 63, ROM (read only memory) 64, CPU (microprocessor) 65, input port 66, and output port 67, which are connected with each other through a bidirectional bus 62.

At the intake pipe 32, at the upstream side of the compressor 34 of the exhaust turbocharger 5 in the direction of flow of intake, an air-flow meter 71 is provided for detecting the amount of flow of air flowing through the intake pipe 32. At the throttle valve 36, a throttle opening degree sensor 72 is provided for detecting its opening degree (throttle opening degree). In addition, at the intake manifold 31, a pressure sensor 73 is provided for detecting the pressure of the intake gas in the intake manifold 31 (boost pressure). Further, at the exhaust manifold 41, a pressure sensor 73 is provided for detecting the pressure of the exhaust gas in the exhaust manifold 41 (exhaust pressure). The outputs of the air flow meter 71, throttle opening degree sensor 72, and pressure sensors 73 and 77 are input through corresponding AD converters 68 to the input port 66.

Further, a load sensor 75 generating an output voltage proportional to the amount of depression of an accelerator pedal 74 is connected to the accelerator pedal 74. The output voltage of the load sensor 75 is input through a corresponding AD converter 68 to the input port 66. Therefore, in the present embodiment, the amount of depression of the accelerator pedal 87 is used as the engine load. A crank angle sensor 76 generates an output pulse every time the crankshaft of the engine body 10 rotates by for example 10 degrees. This output pulse is input to the input port 66. At the CPU 65, the engine speed is calculated from the output pulse of this crank angle sensor 76.

On the other hand, the output port 67 of the ECU 61 is connected through corresponding driver circuits 69 to the actuators controlling the operation of the internal combustion engine 1. In the example shown in FIG. 1, the output port 67 is connected to the fuel injectors 21, fuel pump 24, throttle valve drive actuator 37, and EGR control valve 52. The ECU 61 outputs control signals controlling these actuators from the output port 67 to control the operation of the internal combustion engine 1.

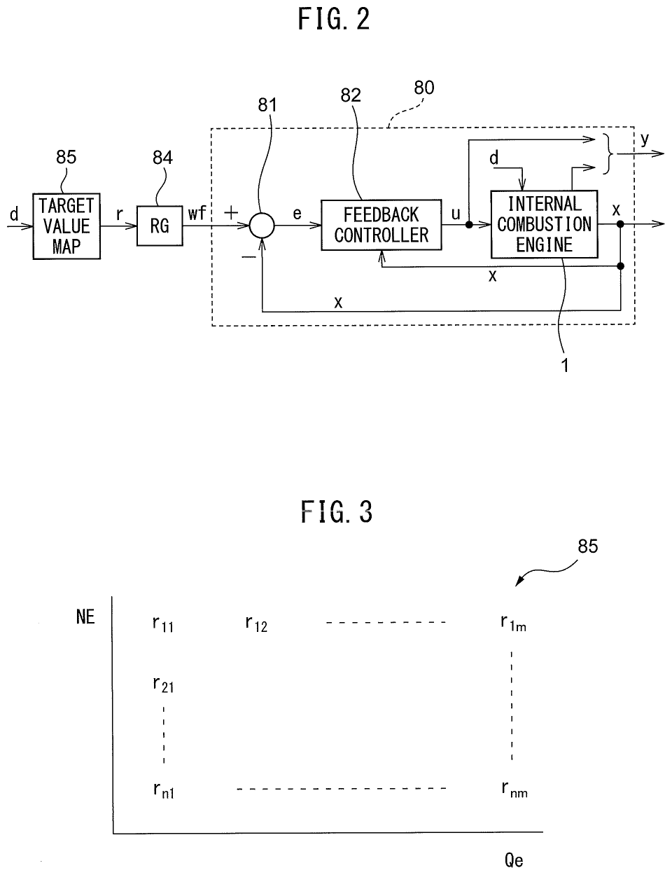

Next, control of the internal combustion engine performed by the controller 60 will be explained with reference to FIG. 2. As shown in FIG. 2, the controller 60 comprises a target value map 85, a reference governor (RG) 84, a comparison part 81, and a feedback controller 82. The portion surrounded by the dashed line in FIG. 2 functions as a closed-loop system 80 that performs feedback control so that the control output x of the internal combustion engine 1 approaches the target value wf.

The comparison part 81 subtracts the control output x from the target value wf to calculate a deviation e (=wf−x), and inputs the deviation e to the feedback controller 82. The target value wf is input to the comparison part 81 by the reference governor 84, which is described later, and the control output x is output from the internal combustion engine 1, to which a control input u and an exogenous input d are input. The exogenous input d is a predetermined parameter of the internal combustion engine 1.

The feedback controller 82 determines the control input u of the internal combustion engine 1 so that the control output x approaches the target value wf. In other words, the feedback controller 82 determines the control input u so that the deviation e approaches zero. Known control such as PI control or PID control is used in the feedback controller 82. The feedback controller 82 inputs the control input u to the internal combustion engine 1. Furthermore, the control output x is input to the feedback controller 82 as state feedback. Note that, the input of the control output x to the feedback controller 82 may be omitted. Furthermore, the comparison part 81 may be incorporated in the feedback controller 82.

As described above, feedback control is performed in the closed-loop system 80 so that the control output x approaches the target value wf. However, during actual control, the state quantities y are constrained due to hardware or control constraints. Thus, if the target values calculated without taking the constraints into account are input to the closed-loop system 80, the state quantities y conflict with the constraints, and there is a risk of deterioration of transient response and control instability.

In the present embodiment, the target value wf of the control output x is calculated using the target value map 85 and the reference governor 84. When the exogenous input d is input to the target value map 85, the target value map 85 calculates a provisional target value r based on the exogenous input d, and outputs the provisional target value r to the reference governor 84. Thus, the target value map 85 functions as a provisional target value calculation part for calculating the provisional target value r of the control output x based on predetermined operating parameters of the internal combustion engine 1.

The reference governor 84 derives the target value wf by correcting the provisional target value r so that the degree of satisfaction of the constraint condition related to the state quantity y is high. Specifically, the reference governor 84 derives the target value wf so as to decrease the value of the objective function determined so that the value decreases as the degree of satisfaction of the constraint condition related to the state quantity y becomes higher.

In the present embodiment, the control output x includes boost pressure and EGR rate. The boost pressure, which is input to the comparison part 81 as the control output x, is detected by the pressure sensor 73. Furthermore, the EGR rate, which is input to the comparison part 81 as the control output x, is estimated by a known method based on the degree of opening of the EGR control valve 52 or the like. Note that in the present embodiment, the control output x, provisional target value r, target value wf, etc., are represented by two-dimensional vectors.

The control input u for controlling the boost pressure and the EGR rate includes the degree of opening of the throttle valve 36, the degree of opening of the EGR control valve 52, and the degree of opening of the variable nozzle of the exhaust turbocharger 5. The exogenous input d includes the engine rotation speed and the fuel injection amount, which are operating parameters of the internal combustion engine 1. The engine rotation speed is detected by the crank angle sensor 76. The fuel injection amount is determined by the ECU 61 based on an engine load detected by the load sensor 75, etc. In the target value map 85, the provisional target value r is represented by a function of the engine rotation speed NE and the fuel injection amount Qe.

Furthermore, the boost pressure and the EGR rate have upper limits as constraint conditions. Likewise, the turbine rotation speed and exhaust pressure of the exhaust turbocharger 5 have upper limits as constraint conditions. Thus, in the present embodiment, the state quantity y includes the boost pressure and the EGR rate, which are control outputs x, and the turbine rotation speed and exhaust pressure. At this time, the objective function J(w) is defined by Formula (1) as follows.

J(w)=∥r−w∥²=Sₚᵢₘ+S_{EGR}+S_{Nt}+Sₚₑₓ (1)

r is the provisional target value output from the target value map 85, and w is the correction target value. The objective function J₁(w) includes a correction term (the first term on the right side of Formula (1)), a first penalty function Sₚᵢₘ, a second penalty function S_{EGR}, a third penalty function S_{Nt}, and a fourth penalty function Sₚₑₓ.

The correction term represents the correction amount of the target value, and is the square of the difference between the provisional target value r and the correction target value w. Thus, the value of the objective function J(w) decreases as the difference between the provisional target value r and the correction target value w decreases, i.e., as the correction amount of the target value decreases.

The first penalty function Sₚᵢₘ represents the degree of satisfaction of the constraint condition related to boost pressure, and is defined by Formula (2) as follows.

$${S}_{pim} = {p}_{1} {\sum }_{k = 1}^{Nh} max \{ {x}_{1} - {x}_{1 Lim} , 0 \} \qquad ( 2 )$$

x₁(k) is the boost pressure future prediction value, x_{1Lim} is the predetermined upper limit of the boost pressure, and p₁ is a predetermined weighting coefficient. Furthermore, k is a discrete time step and Nh is a prediction step number (prediction horizon). The first penalty function Sₚᵢₘ is configured such that an exceeded amount is added to the objective function J(w) as a penalty when the boost pressure future prediction value x₁(k) exceeds the upper limit value x_{1Lim}. Thus, the value of the objective function J(w) decreases as the total amount, by which the boost pressure future prediction value x₁ (k) exceeds the upper limit value x_{1Lim,} decreases.

The reference governor 84 calculates the boost pressure future prediction value x₁(k) using a model of the internal combustion engine 1. The reference governor 84 calculates, for example, the boost pressure future prediction value x₁(k) by Formula (3) as follows.

x₁(k+1)=f₁(x₁(k),w,d) (3)

f₁ is a model function used for calculating the boost pressure future prediction value x₁(k). First, a prediction value x₁(1) of the boost pressure one step after the calculation time point is calculated using x₁(0), which is the boost pressure at the calculation time point. x₁(0), which is the boost pressure at the calculation time point, is detected by the pressure sensor 73. Thereafter, the future prediction values x₁(k) of the boost pressure are sequentially calculated from the calculation time point to the boost pressure prediction value x₁(Nh) of the Nh step, and the future prediction values of a total of Nh boost pressures are calculated. Note that the value obtained by multiplying the time corresponding to one step by the prediction step number Nh is the prediction period.

The second penalty function S_{EGR} represents the degree of satisfaction of the constraint condition related to the EGR rate, and is defined by Formula (4) as follows.

$${S}_{EGR} = {p}_{2} {\sum }_{k = 1}^{Nh} max \{ {x}_{2} ( k ) - {x}_{2 Lim} , 0 \} \qquad ( 4 )$$

x₂(k) is the EGR rate future prediction value, x_{2Lim} is the predetermined upper limit value of the EGR rate, and p₂ is a predetermined weight coefficient. The second penalty function S_{EGR} is configured such that an exceeded amount is added to the objective function J(w) as a penalty when the EGR rate future prediction value x₂(k) exceeds the upper limit value x_{2Lim}Thus, the value of the objective function J(w) decreases, as the total amount, by which the EGR rate future prediction value x₂(k) exceeds the upper limit value x_{2Lim}, decreases.

The reference governor 84 calculates the EGR rate future prediction value x₂(k) using a model of the internal combustion engine 1. The reference governor 84 calculates, for example, the EGR rate future prediction value x₂(k) by Formula (5) as follows.

x₂(k+1)=f₂(x₂(k),w,d) (5)

f₂ is a model function used for calculating the EGR rate future prediction value x₂(k). First, a prediction value x₂(1) of the EGR rate one step after the calculation time point is calculated using x₂(0), which is the EGR rate at the calculation time point. x₂(0), which is the EGR rate at the calculation time point, is estimated by a known method based on the degree of opening of the EGR valve 63. Thereafter, the future prediction values x₂(k) of the EGR rate are sequentially calculated from the calculation time point to the EGR rate prediction value x₂(Nh) of the Nh step, and the future prediction values of a total of Nh EGR rates are calculated.

The third penalty function S_{Nt} represents the degree of satisfaction of the constraint condition related to the turbine rotation speed, and is defined by Formula (6) as follows.

$${S}_{Nt} = {p}_{3} {\sum }_{k = 1}^{Nh} max \{ {x}_{3} ( k ) - {x}_{3 Lim} , 0 \} \qquad ( 6 )$$

x₃(k) is the turbine rotation speed future prediction value, x_{3Lim} is the predetermined upper limit value of the turbine rotation speed, and p₃ is a predetermined weight coefficient. The third penalty function S_{Nt} is configured such that an exceeded amount is added to the objective function J(w) as a penalty when the turbine rotation speed future prediction value x₃(k) exceeds the upper limit value x_{3Lim}. Thus, the value of the objective function J(w) decreases, as the total amount, by which the turbine rotation speed future prediction value x₃(k) exceeds the upper limit value x_{3Lim}, decreases.

The reference governor 84 calculates the turbine rotation speed future prediction value x₃(k) using a model of the internal combustion engine 1. The reference governor 84 calculates, for example, the turbine rotation speed future prediction value x₃(k) by Formula (7) as follows.

x₃(k+1)=f₃(x₃(k),w,d) (7)

f₃ is a model function used for calculating the turbine rotation speed future prediction x₃(k). First, a prediction value x₃(1) of the turbine rotation speed one step after the calculation time point is calculated using x₃(0), which is the turbine rotation speed at the calculation time point. x₃(0). x₃(0), which is the turbine rotation speed at the calculation time point, is detected by, for example, a turbine rotation speed sensor (not illustrated) provided in the turbine 43. Thereafter, the future prediction values x₃(k) of the turbine rotation speed are sequentially calculated from the calculation time point to the turbine rotation speed prediction value x₃(Nh) of the Nh step, and the future prediction values of a total of Nh turbine rotation speeds are calculated.

In particular, in the present embodiment, the turbine rotation speed future prediction value x₃(k) is calculated by Formula (8) as follows.

x₃(k+1)=A·x₃(k)+B·w₁(k)+C·w₂(k)+D·d₁(k) (8)

In Formula (8), w₁ represents the correction target value of the boost pressure, w₂ represents the correction target value of the EGR rate, and d₁ represents the fuel injection amount. A to D represent coefficients which changes, depending on the operating condition of the engine, i.e., depending on the engine rotation speed and the fuel injection amount, which are operating parameters of the internal combustion engine 1. The coefficients A to D are values determined in advance experimentally or by calculation for each engine operating state and are stored in the ROM 64 of the ECU 61 as a map.

The fourth penalty function Sₚₑₓ represents the degree of satisfaction of the constraint condition related to the exhaust pressure, and is defined by Formula (9) as follows.

$${S}_{pex} = {p}_{4} {\sum }_{k = 1}^{Nh} max \{ {x}_{4} ( k ) - {x}_{4 Lim} , 0 \} \qquad ( 9 )$$

x₄(k) is the exhaust pressure future prediction value, x_{4Lim} is the predetermined upper limit value of the exhaust pressure, and p₄ is a predetermined weight coefficient. The fourth penalty function Sₚₑₓ is configured such that an exceeded amount is added to the objective function J(w) as a penalty when the exhaust pressure future prediction value x₄(k) exceeds the upper limit value x_{4Lim}. Thus, the value of the objective function J(w) decreases, as the total amount, by which the exhaust pressure future prediction value x₄(k) exceeds the upper limit value x_{4Lim}, decreases.

The reference governor 84 calculates the exhaust pressure future prediction value x₄(k) using a model of the internal combustion engine 1. The reference governor 84 calculates, for example, the exhaust pressure future prediction value x₄(k) by Formula (10) as follows.

x₄(k+1)=f₄(x₄(k),w,d) (10)

f₄ is a model function used for calculating the exhaust pressure future prediction value x₄(k). First, a prediction value x₄(1) of the exhaust pressure one step after the calculation time point is calculated using x₄(0), which is the exhaust pressure at the calculation time point. x₄(0), which is the exhaust pressure at the calculation time point, is detected by, for example, the pressure sensor 77 provided in the exhaust manifold 41. Thereafter, the future prediction values x₄(k) of the exhaust pressure are sequentially calculated from the calculation time point to the exhaust pressure prediction value x₄(Nh) of the Nh step, and the future prediction values of a total of Nh exhaust pressures are calculated.

In particular, in the present embodiment, the exhaust pressure future prediction values x₄(k) are calculated by Formula (11) as follows.

x₄(k+1)=E·x₄(k)+F·w₁(k)+G·w₂(k)+H·d₁(k) (11)

In Formula (11), E to H represent coefficients, which changes depending on the operating condition of the engine, i.e., depending on the engine rotation speed and the fuel injection amount, which are operating parameters of the internal combustion engine 1. The coefficients E to H are values determined in advance experimentally or by calculation for each engine operating state and are stored in the ROM 64 of the ECU 61 as a map.

### <<Target Value Derivation Processing>>

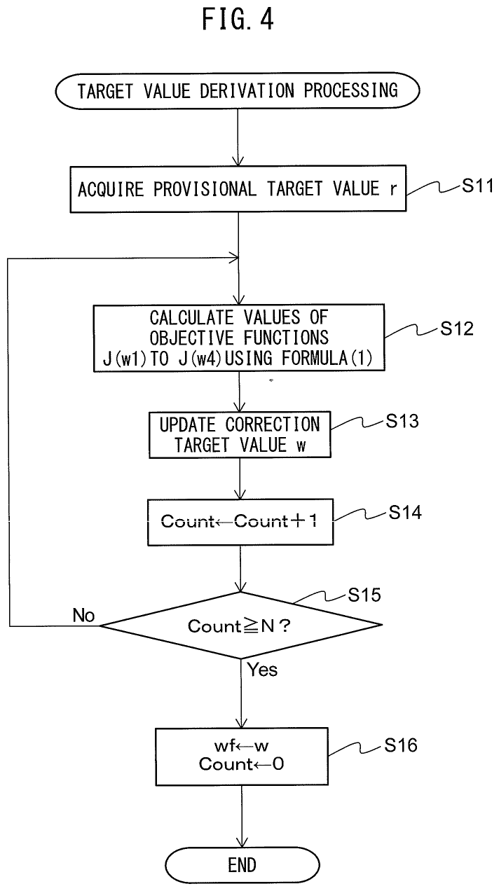

As described above, the reference governor 84 derives the target value wf so as to decrease the value of the objective function determined so that the value decreases as the degree of satisfaction of the constraint condition related to the state quantity y becomes higher. The target value derivation processing of the reference governor 84 will be described below with reference to FIG. 4. FIG. 4 is a flowchart showing the control routine of normal target value derivation processing of the present embodiment. The present control routine is executed by the ECU 61 at predetermined time intervals.

First, in step S11, the provisional target value r of the control output x (boost pressure and EGR rate in the present embodiment) calculated, based on the exogenous input d, using the target value map 85, is acquired.

Next, in step S12, in order to search for the optimum value of the correction target value w by the gradient method, the values of the objective function J(wₐ) to J(w_{d}) in the four neighboring target values wₐ to w_{d} which are distant from the current correction target value w by a predetermined distance, are calculated by the above Formula (1). At this time, each term of the objective function J(w) of the above Formula (1) is calculated using the neighboring target values wₐ to w_{d} as correction target values w. The initial value of the correction target value w is the provisional target value r.

Next, in step S13, the correction target value w is moved in the direction of the gradient calculated from the values of the objective functions J(wₐ) to J(w_{d}). In other words, the correction target value w is updated. Specifically, the correction target value w set to the neighboring target value having the smallest objective function J(w) from among the neighboring target values wₐ to w_{d}. Next, in step S14, 1 is added to the update counter Count. The update counter Count represents the number of times that the correction target value w has been updated. The initial value of the update counter Count is 0.

Next, in step S15, it is judged whether or not the update counter Count is equal to or greater than a predetermined repetition number N, which is, for example, 5 to 200. If it is judged in step S15 that the update counter Count is less than the predetermined repetition number N, the present control routine returns to step S12. Thus, the optimum value of the correction target value w is repeatedly searched until the update counter Count reaches the predetermined number of repetitions N.

If it is judged in step S15 that the update counter Count is equal to or greater than the predetermined number of repetitions N, the present control routine proceeds to step S16. In step S16, the target value wf of the control output x is set to the final correction target value w. Furthermore, in step S16, the update counter Count is reset to zero. After step S16, the present control routine ends.

Note that as long as the correction target value w can be updated so as to decrease the value of the objective function, the correction target value w may be updated by a method other than the gradient method.

### <<Reduction of Calculation Load>>

When the target value wf of the control output x is derived in the reference governor 84 as described above, repetitive calculations to calculate the objective function are performed and the objective function itself is also repeatedly calculated. Thus, when deriving the target value wf, the calculation load on the ECU 61 is high.

In particular, the target value wf is calculated by the reference governor 84 each time the internal combustion engine 1 rotates by a predetermined angle. Thus, when the engine rotation speed is low, the calculation load of the ECU 61 does not exceed the limit even if the target value wf is derived by the reference governor 84 using the normal target value derivation processing described above. However, when the engine rotation speed is high, if the target value wf is derived by the reference governor 84 using the normal target value derivation processing, the calculation load of the ECU 61 will exceed the limit, which results in the occurrence of computational lapses (for example, the number of repetitions in the reference governor 84 decreases). Thus, when the calculation load of the ECU 61 becomes excessively high, such as when the engine rotation speed is high, it is necessary to reduce the calculation load.

In the present embodiment, when the calculation load of the ECU 61 is excessively high, the reference governor 84 derives the target value wf by correcting the provisional target values r of the plurality of control outputs x based on the current value of the state quantity y so as to satisfy the constraint condition related to the state quantity y, using a model that outputs the relationship between the correction amounts (hereinafter referred to as “target value correction amounts”) Δw from provisional target values r of the plurality of control outputs x, which satisfy the constraint condition of that state quantity y, by inputting the current value of state quantity y. Additionally, in the present embodiment, when deriving the target value wf, the ratio of the target value correction amounts Δw between the plurality of control outputs x is set to a predetermined correction ratio, and these correction ratios are set based on the values of the operating parameters of the internal combustion engine (e.g., engine rotation speed and fuel injection amount). Such a method for deriving a target value wf will be described in detail below.

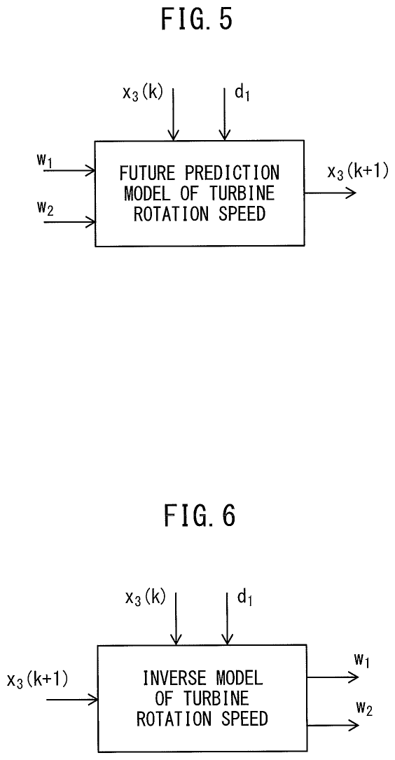

The future prediction value x₃ of the turbine rotation speed is calculated by Formula (8) below as described above. Formula (8) can be used as a turbine rotation speed future prediction model that outputs the future prediction value x₃(k+1) of the turbine rotation speed when the correction target value w₁ of the boost pressure and the correction target value w₂ of the EGR rate are input, as shown in FIG. 5. Furthermore, in addition to the correction target values w₁, w₂, it is necessary to input the current turbine rotation speed x₃(k) and the current fuel injection amount d₁ to this turbine rotation speed future prediction model.

x₃(k+1)=A·x₃(k)+B·w₁(k)+C·w₂(k)+D·d₁(k) (8)

Conversely, when the inputs and outputs of the turbine rotation speed future prediction model shown in FIG. 5 are reversed, Formula (8) can be used as an inverse model of the future prediction model described above, which outputs the correction target value w₁ of the boost pressure and the correction target value w₂ of the EGR rate when the future prediction value x₃(x+1) of the turbine rotation speed is input, as shown in FIG. 6. Furthermore, as shown in FIG. 6, in addition to the future prediction value x₃(x+1) of the turbine rotation speed, it is also necessary to input the current turbine rotation speed x₃(k) and the current fuel injection amount d₁ to this inverse model.

In this regard, when the upper limit value x_{3Lim}, which is the constraint condition, is input to the inverse model as the future prediction value x₃(k+1) of the turbine rotation speed, the relationship between the target value w_{1Lim} of the boost pressure and the target value w_{2Lim} of the EGR rate such that the turbine rotation speed becomes the upper limit value x_{3Lim} in the future, can be obtained by the following Formula (12).

B·W_{1Lim}+C·w_{2Lim}=x_{3Lim}−A·x_{3cr}−D·d_{1cr} (12)

Note that Formula (12) is derived from Formula (8) by substituting the current turbine rotation speed x₃cr in place of x₃(k), and the current fuel injection amount d₁cr in place of d₁ of Formula (8).

The target value w_{1Lim} of the boost pressure such that the turbine rotation speed becomes the upper limit value in the future can be expressed as the value obtained by adding the target value correction amount Δw₁ to the provisional target value r₁ (w_{1Lim}=r₁+Δw₁). Additionally, the target value w_{2Lim} of the EGR rate such that the turbine rotation speed becomes the upper limit value in the future can be expressed as the value obtained by adding target value correction amount Δw₂ to the provisional target value r₂ (w_{2Lim}=r₂+Δw₂). Thus, Formula (12) can be represented as Formula (13) below.

B·(r₁+Δw₁)+C·(r₂+Δw₂)=x_{3Lim}−A·x_{3cr}−D·d_{1cr} (13)

According to Formula (13) above, by inputting the current value of the turbine rotation speed, which is a state quantity, the relationship between the target value correction amount of the boost pressure and the target value correction amount of the EGR rate such that the turbine rotation speed becomes the upper limit value (i.e., such that the constraint conditions of the state quantities are satisfied) can be obtained. Thus, in the inverse model, by inputting the current value of the state quantity (turbine rotation speed), the relationship between the correction amounts from the provisional target values of the plurality of control outputs such that the constraint condition of this state quantity is satisfied (the relationship between the target value correction amount of the boost pressure and the target value correction amount of the EGR rate) is output.

In Formula (13), the variables are the target value correction amount Δw₁ of the boost pressure and the target value correction amount Δw₂ of the EGR rate. Thus, in Formula (13), since there are two variables in a single equation, Formula (13) cannot be simply solved in order to find the target value correction amount Δw₁ of the boost pressure and the target value correction amount Δw₂ of the EGR rate.

On the other hand, the coefficients A to D in Formula (8) represent the sensitivity of each parameter x₃, w₁, w₂, and d₁ to the future turbine rotation speed. Thus, the larger the values of the coefficients A to D to be multiplied, the larger the rate of change of the turbine rotation speed with respect to the change of the parameters. In other words, the future turbine rotation speed changes greatly even if the values of the parameters change slightly, as the values of the multiplication coefficients A to D increase. On the other hand, as the values of the coefficients A to D to be multiplied become smaller, the future turbine rotation speed does not change unless the values of the parameters change greatly.

The provisional target value r calculated by the target value map 85 is set to an optimum value in accordance with the engine operation state. Thus, even when the provisional target value r is corrected using the reference governor 84, it is preferable that the correction amount be as small as possible.

In the present embodiment, the target value correction amount Δw₁ of the boost pressure and the target value correction amount Δw₂ of the EGR rate are calculated so that the ratio thereof is the ratio of coefficient B to coefficient C described above (Δw₁:Δw₂=B:C). Specifically, Δw₂ is calculated by substituting Δw₁=B/C·Δw₂ in Formula (13), and Δw₁ is calculated based on Δw₂. Note that in the present description, the ratio of the correction amounts w of the provisional target values r between the plurality of control outputs x (B/C in the present embodiment) is referred to as the correction ratio.

When the ratio of the target value correction amount Δw₁ of the boost pressure and the target value correction amount Δw₂ of the EGR rate are set in this manner, the target value of the control output x having the highest sensitivity is corrected by a greater degree. Thus, according to the present embodiment, the target value correction amount Δw₁ of the boost pressure and the target value correction amount Δw₂ of the EGR rate can be calculated so that the turbine rotation speed becomes the upper limit value while minimizing the target value correction amounts Δw₁ and Δw₂ of the boost pressure and EGR rate as a whole.

Furthermore, as described above, coefficients A to D of Formula (8) described above are obtained for each engine operation state. In other words, the coefficients A to D change depending on the engine operation state. Therefore, the correction ratio when correcting the target value correction amount Δw₁ of the boost pressure and the target value correction amount Δw₂ of the EGR rate also changes depending on the engine operation state. Thus, in the present embodiment, the correction ratio is set based on the engine operation state, i.e., based on the operating parameters of the internal combustion engine 1 (e.g., the engine rotation speed and the fuel injection amount). By setting the correction ratio based on the engine operation state in this manner, appropriate target value correction amounts Δw₁, Δw₂ of the boost pressure and the EGR rate can be calculated in accordance with the engine operation state.

Note that in the embodiment described above, the upper limit value x_{3Lim}, which is a constraint condition, is input to the inverse model as the future prediction value x₃(k+1) of the turbine rotation speed, and the target value correction amount Δw₁ of the boost pressure and the target value correction amount Δw₂ of the EGR rate are calculated so that the turbine rotation speed becomes the upper limit value. However, as long as the future prediction value x₃(k+1) of the turbine rotation speed is a value that satisfies the constraint condition, a value other than the upper limit value x_{3Lim} (e.g., a predetermined value less than the upper limit value x_{3Lim}) may be input to the future prediction value x₃(k+1) of the turbine rotation speed. Even in such a case, the target value correction amount Δw₁ of the boost pressure and the target value correction amount Δw₂ of the EGR rate are calculated so that the turbine rotation speed satisfies the constraint condition.

Furthermore, in the embodiment described above, the correction ratio is set to the value (B/C) obtained by dividing coefficient R of Formula (8) by coefficient C of Formula (8). However, it is not necessarily critical that the correction ratio be set to B/C. The correction ratio may be set to a value different from B/C. By increasing the target value correction amount of the boost pressure or the EGR rate, whichever has higher sensitivity, the target value correction amounts Δw₁ and Δw₂ of the boost pressure and EGR rate can be minimized as a whole. Thus, it is preferable that the correction ratio be corrected so that the provisional target value of the control output having higher sensitivity, i.e., the provisional target value of the control output having the largest absolute value among the coefficient B, C to be multiplied, is relatively large.

Further, the coefficients A to D changes for each engine operation state, as described above. Thus, even when the correction ratio is set to a value different from B/C, the optimal value of the correction ratio changes in accordance with the engine operation state. Therefore, even when the correction ratio is set to a value different from B/C, the correction ratio is set based on the engine operation state, i.e., based on the values of the operating parameters of the internal combustion engine.

<<Flowchart>>

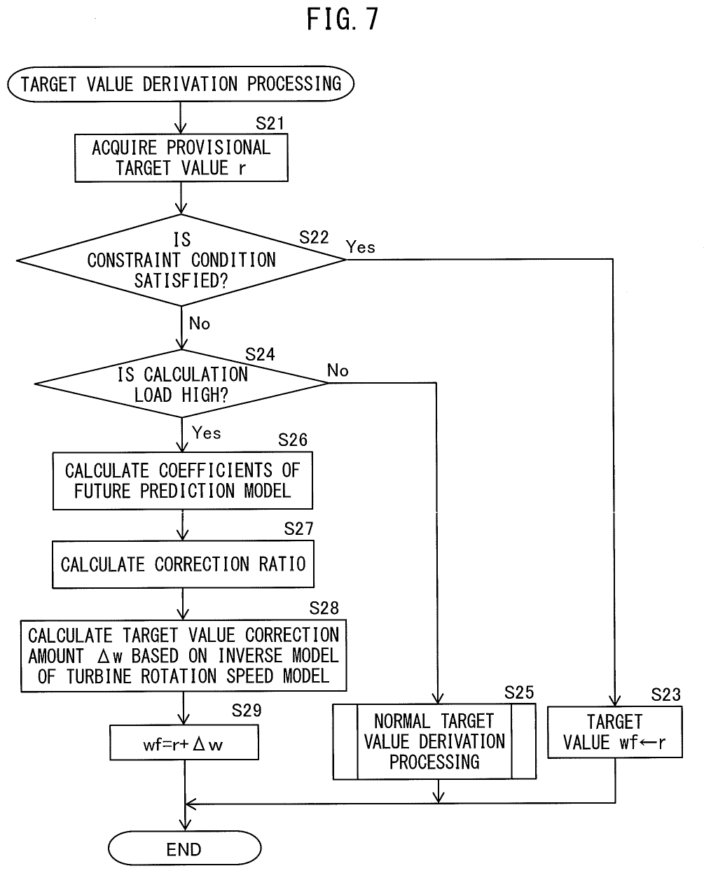

FIG. 7 is a flowchart showing the control routine of the target value calculation processing for calculating the target values of boost pressure and EGR rate, which are control outputs. The illustrated control routine is executed at regular time intervals.

As shown in FIG. 7, first, in step S21, the provisional target values r of the boost pressure and EGR rate (the provisional target value r₁ of the boost pressure and the provisional target value r₂ of the EGR rate), which are control outputs, are acquired based on the engine operation state (e.g., the engine rotation speed and the fuel injection amount) using a map as shown in FIG. 3. The engine operation state is detected based on various sensors provided in the internal combustion engine 1. The engine rotation speed is calculated based on the output of the crank angle sensor 76, and the fuel injection amount is calculated based on a control signal supplied to the fuel injection valve 21.

Next, in step S22, if it is assumed that the target values of the boost pressure and the EGR rate have been set to the provisional target values r calculated in step S21, it is judged whether or not the turbine rotation speed, which is a state quantity, is expected to be maintained while the constraint condition is satisfied in detail. Specifically, the future prediction values x₃ of the turbine rotation speed are calculated from the calculation time point to the Nh step using Formula (8) described above. When any one of the plurality of calculated future prediction values x₃ is equal to or less than the upper limit value as a constraint condition, in step S22, it is judged that the turbine rotation speed shall be maintained while the constraint conditions will be satisfied in the future. In this case, the control routine proceeds to step S23, the target values wf of the boost pressure and the EGR rate (target value wf₁ of the boost pressure and target value wf₂ of the EGR rate), which are control outputs, are set to the provisional target values r calculated in step S21, and the control routine ends. Conversely, in step 22, when it is judged that turbine rotation speed is unlikely to satisfy the constraint condition in the future, the process proceeds to step S24.

In step S24, it is determined whether or not the calculation load of the ECU 61 is higher than a predetermined upper limit load. Specifically, for example, since the higher the engine rotation speed becomes, the higher the calculation frequency for calculating the target value becomes, when the engine rotation speed is less than a predetermined upper limit speed, it is judged that the calculation load is low, and when the engine rotation speed is equal to or greater than the upper limit speed, it is determined that the calculation load is high. Furthermore, if some or all of the plurality of repetitions of derivation of the objective function based on Formula (1) above are skipped during execution of a prior control routine, it is determined that the calculation load is high.

When it is determined in step S24 that the calculation load is equal to or less than the predetermined upper limit load, the process proceeds to step S25. In step S25, the target values wf of the EGR rate and the boost pressure are calculated by executing the normal target value derivation processing shown in FIG. 4, and thereafter the control routine ends.

Conversely, when it is judged in step S24 that the calculation load is higher than the predetermined upper limit load, the process proceeds to step S26. In step S26, the coefficients A to D of the turbine rotation speed future prediction model shown in FIG. 5 are calculated. Specifically, the relationships between the engine operation state and each coefficient is stored in the ROM 64 of the ECU 61 in advance as maps or calculation formulae. Each coefficient A to D is calculated based on the current engine operation state using the map or the like stored in the ROM 64 of the ECU 61.

Next, in step S27, the correction ratio is calculated based on the coefficients calculated in step S26. In the present embodiment, the correction ratio is set to a value obtained by dividing coefficient B by coefficient C. Next, in step S28, the target value correction amounts Δw of the boost pressure and EGR rate are calculated based on the correction ratio calculated in step S27 using the inverse model shown in FIG. 6 (using Formula (13)). Next, in step S29, the target values wf of the boost pressure and EGR rate are calculated based on the provisional target values r of the boost pressure and EGR rate acquired in step S21 and the target value correction amounts Δw of the boost pressure and EGR rate calculated in step S28, and thereafter the control routine ends.

### <<Modification>>

In the embodiment descried above, the target values of the boost pressure and EGR rate are calculated so that the turbine rotation speed becomes the upper limit value in the future. However, the target values of the boost pressure and the EGR rate may be calculated so that another state quantity of the internal combustion engine becomes the upper limit value in the future. Examples of such state quantities include exhaust pressure, boost pressure, EGR rate, etc. The case in which exhaust pressure is used as the state quantity will be briefly described below.

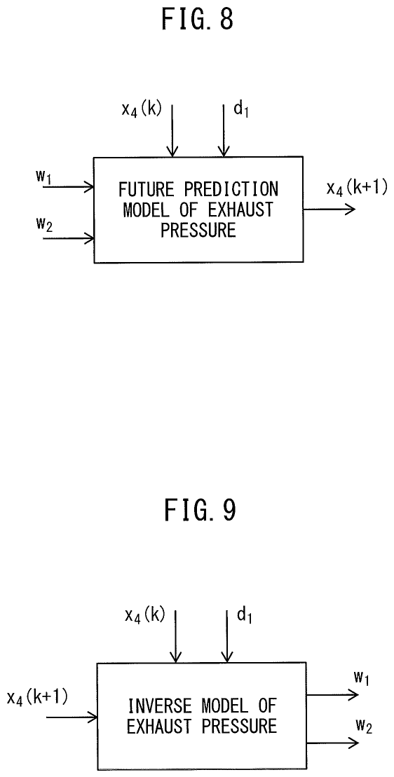

The exhaust pressure future prediction value x₄ is calculated by Formula (11) described above. This formula, as shown in FIG. 8, can be used as an exhaust pressure future prediction model. Conversely, when the inputs and outputs of the exhaust pressure future prediction model shown in FIG. 8 are reversed, Formula (11) can be used as an inverse model of the above future prediction model, which outputs the correction target value w₁ of the boost pressure and the correction target value w₂ of the EGR rate when the future prediction value x₄(x+1) of the exhaust pressure is input.

When the upper limit value x_{4Lim}, which is a constraint condition, is input to the inverse model as the future prediction value x₄(k+1) of the exhaust pressure, the relationship between the target value of the boost pressure and the target value of the EGR rate such that exhaust pressure becomes the upper limit value x₄Lim in the future, can be obtained by the following Formulae (14) and (15).

F·w_{1Lim}+G·w_{2Lim}=x_{4Lim}−E·x_{4cr}−H·d_{1cr} (14)

F·(r₁+Δw₁)+G·(r₂+Δw₂)=x_{4Lim}−E·x_{4cr}−H·d_{1cr} (15)

Note that Formula (14) is derived by substituting the current exhaust pressure x₄cr in place of the x₄(k) of Formula (11), and by substituting the current fuel injection amount d₁cr in place of d₁ of Formula (11).

The target value correction amount Δw₁ of the boost pressure and the target value correction amount Δw₂ of the EGR rate are calculated such that the ratio thereof becomes the ratio (correction ratio) of coefficient F to coefficient G described above (Δw₁:Δw₂=F:G). Specifically, Δw₂ is calculated by substituting Δw₁=F/G·Δw₂ into Formula (15), and Δw₁ is calculated based on Δw₂.

Note that similarly to the embodiment described above, it is not necessarily critical that the correction ratio be set to F/G. The correction ratio may be set to a value different from F/G. Furthermore, since the coefficients E to H change for each engine operation state, the correction ratio is preferably set based on the engine operation state, i.e., based on the values of the operating parameters of the internal combustion engine.

Furthermore, in the embodiment described above, the boost pressure and EGR rate are used as the control outputs for which the target values are set. However, the control value for which a target value is set may be another parameter such as NOx concentration in the exhaust gas.

### Second Embodiment

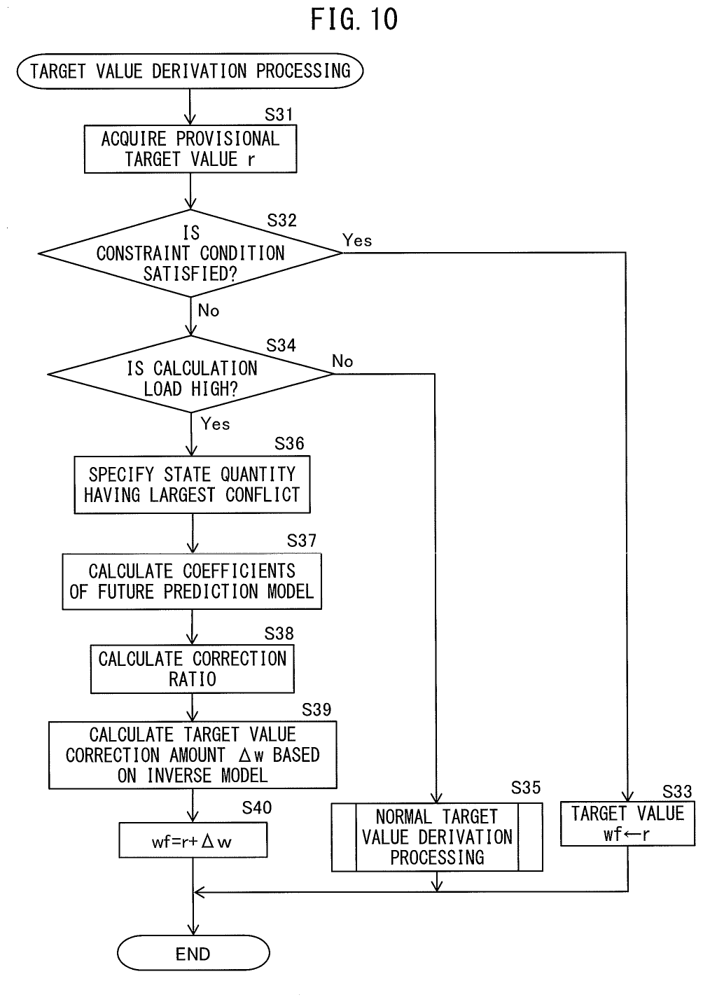

Next, a controller for the internal combustion engine 1 according to a second embodiment will be described with reference to FIG. 10. The structure and control of the controller according to the second embodiment is fundamentally identical to the structure and control of the controller according to the first embodiment. The portions which differ from the controller according to the first embodiment will be mainly described below.

In the first embodiment described above, the target value wf of the control output x is calculated so that a constraint condition of one of the plurality of parameters representing the state quantity is satisfied. However, if there are multiple parameters representing the state quantity, even if the target value is calculated so that one of the parameters satisfies the constraint condition, all of the parameters representing the state quantity may not satisfy the constraint conditions thereof.

In the present embodiment, when it is predicted that the constraint conditions related to the plurality of state quantities will not be satisfied assuming that the target values of the plurality of control outputs x are set to the respective provisional target values r, the target values are derived so that the constraint condition of the state quantity having a greater degree of conflict with the constraint conditions of the plurality of state quantities is satisfied. The case in which turbine rotation speed and exhaust pressure are used as state quantities will be described as an example below.

As described above, the third penalty function S_{Nt} shown in Formula (6) above represents the degree of satisfaction of the constraint condition related to turbine rotation speed, i.e., the magnitude of the degree of conflict with the constraint condition related to turbine rotation speed. The larger the value of the third penalty function S_{Nt}, the greater the degree of conflict with the constraint condition. The fourth penalty function Sₚₑₓ shown in Formula (9) represents the degree of satisfaction of the constraint condition related to exhaust pressure, i.e., the magnitude of the degree of conflict with the constraint condition related to the exhaust pressure. The larger the value of the fourth penalty function Sₚₑₓ, the greater the degree of conflict with the constraint condition.

In the present embodiment, the value of the third penalty function S_{Nt} and the value of the fourth penalty function Sₚₑₓ are compared, and when the value of the third penalty function S_{N}t is larger, the target values of the boost pressure and EGR rate, which are control outputs, are derived so that the turbine rotation speed satisfies the constraint condition. Conversely, when the value of the fourth penalty function Sₚₑₓ is larger as a result of the comparison, the target values of the boost pressure and EGR rate, which are control outputs, are derived so that the exhaust pressure satisfies the constraint condition. As a result, the turbine rotation speed and exhaust pressure, which are state quantities, are prevented from greatly conflicting with the constraint conditions.

FIG. 10 is a flowchart showing a control routine of target value calculation processing for calculating the target values of boost pressure and EGR rate, which are control outputs. The illustrated control routine is executed at regular time intervals. Since steps S31 to S35 and S37 to S40 of the flowchart shown in FIG. 10 are identical to steps S21 to S25 and S27 to S29 of FIG. 7, respectively, an explanation thereof has been omitted.

When it is judged in step S34 that the calculation load is higher than the predetermined upper limit load, the process proceeds to step S36. In step S36, the state quantity having the largest conflict with the constraint conditions among the plurality of state quantities is specified. Specifically, the third penalty function S_{Nt} and the fourth penalty function Sₚₑₓ are calculated, and the state quantity corresponding to the penalty function having the larger value thereamong is specified. Next, in steps S37 to S39, the target value wf is calculated so that the specified state value satisfies the constraint condition.

### REFERENCE SIGNS LIST

1 internal combustion engine
5 exhaust turbocharger
52 EGR control valve
61 electronic control unit (ECU)
82 feedback controller
84 reference governor

1. A controller for an internal combustion engine, comprising:
a provisional target value calculation part for calculating provisional target values of a plurality of control outputs of the internal combustion engine based on values of operating parameters of the internal combustion engine,
a reference governor for deriving target values of the control outputs by correcting the provisional target values so that a degree of satisfaction of constraint conditions related to state quantities of the internal combustion engine is high when it is predicted that the constraint conditions related to the state quantities of the internal combustion engine will not be satisfied in the future assuming that the target values of the plurality of control outputs are set to the respective provisional target values, and
a feedback controller for determining control inputs of the internal combustion engine so that the values of the control outputs approach the target values, wherein
the reference governor derives the target values by correcting the provisional target values of the plurality of control outputs, based on the current values of the state quantities, so as to satisfy the constraint conditions related to the state quantities, using a calculation model which outputs a relationship between the correction amounts from the provisional target values of the plurality of control outputs, such that the constraint conditions of the state quantities are satisfied, by inputting the current values of the state quantities, and when deriving the target values, a ratio of the correction amounts from the provisional target values between the plurality of control outputs is set to a predetermined correction ratio, and
the correction ratio is set based on the values of the operating parameters of the internal combustion engine.

2. The controller for an internal combustion engine according to claim 1, wherein the correction ratio is set so that the correction amount from the provisional target value of a control output having a high sensitivity to the state quantities among the plurality of control outputs is relatively high compared to the correction amounts of the provisional target values of the other control outputs.

3. The controller for an internal combustion engine according to claim 1, wherein when a calculation load of the controller is lower than a predetermined load, the reference governor derives the target value without the use of the calculation model so that the value of an objective function, which becomes smaller as the degree of satisfaction of the constraint conditions related to the state quantity becomes higher, decreases.

4. The controller for an internal combustion engine according to claim 1, wherein the internal combustion engine comprises an exhaust turbocharger, and
the state quantities include a turbine rotation speed of the exhaust turbocharger, and the constraint conditions include a condition in which the turbine rotation speed is equal to or lower than a predetermined rotational speed.

5. The controller for an internal combustion engine according to claim 1, wherein the state quantities include an exhaust pressure, and the constraint conditions include a condition in which the exhaust pressure is equal to or lower than a predetermined pressure.

6. The controller for an internal combustion engine according to claim 1, wherein the internal combustion engine comprises an exhaust turbocharger and an EGR system, and
the control outputs include boost pressure and EGR rate.

7. The controller for an internal combustion engine according to claim 1, wherein when it is predicted that the constraint conditions related to the plurality of state quantities of the internal combustion engine will be not satisfied assuming that the target values of the plurality of control outputs have been set to the respective provisional target values, the reference governor derives the target values by correcting the provisional target values of the plurality of control outputs so as to satisfy the constraint condition related to a state quantity having a greater degree of conflict with the constraint conditions from among the plurality of state quantities.

8. The controller for an internal combustion engine according to claim 1, wherein the reference governor comprises a prediction model for outputting future values of the state quantities when the target values of the control outputs and the current values of the state quantities are input, and an inverse prediction model for outputting the target values of the control outputs when the current values and future values of the state quantities are input,
the reference governor judges whether or not the constraint conditions will be satisfied in the future based on future values of the state quantities obtained by inputting the provisional target values of the control outputs and the current values of the state quantities to the prediction model, and
the calculation model is an inverse prediction model.
